(19) United States
(12) Patent Application Publication
(10) Pub. No.: US 2026/0171941 A1
(43) Pub. Date: Jun. 18, 2026

(54) ROTOR POSITION CALIBRATION METHOD AND DEVICE, AND STORAGE MEDIUM

(71) Applicant: Schaeffler Technologies AG & Co. KG, Herzogenaurach (DE)

(72) Inventors: Dongsheng Tao, Kunshan (CN); Zhengtao Lv, Shanghai (CN); Pinkui Luo, Shanghai (CN)

(73) Assignee: Schaeffler Technologies AG & Co. KG, Herzogenaurach (DE)

(21) Appl. No.: 19/126,093

(22) PCT Filed: Nov. 1, 2022
(86) PCT No.: PCT/CN2022/129010

§ 371 Date: Apr. 30, 2025

(51) Int. Cl. H02P 21/16; H02P 21/00; H02P 25/03

(52) U.S. Cl. CPC H02P 21/16; H02P 21/0025; H02P 25/03

(57) ABSTRACT

A method for use in a permanent magnet synchronous motor includes, according to a preset target rotational speed, determining a theoretical position of a target point on a rotor of a motor with respect to a preset target rotational speed at a periodic time point, determining a target driving force according to the target rotational speed, applying the target driving force to the rotor to drive the rotor to rotate, monitoring a real position of the target point at the periodic time point in real time, determining position errors at multiple time points within a preset measurement period according to the theoretical position and the real position, determining an error curve on the basis of the position errors, and calibrating the rotor position on the basis of the error curve.

### CROSS-REFERENCE TO RELATED APPLICATION

This application is a U.S. national stage application under 35 U.S.C. § 371 that claims the benefit of priority under 35 U.S.C. § 365 of International Patent Application No. PCT/CN 2022/129010, filed on Nov. 1, 2022, designating the United States of America, the contents of which are relied upon and incorporated herein by reference in their entirety.

### FIELD OF THE DISCLOSURE

The present disclosure relates to the technical field of permanent magnet synchronous motors, and in particular to a rotor position calibration method, a rotor position calibration device, and a storage medium.

### BACKGROUND OF THE DISCLOSURE

A permanent magnet synchronous motor can be an alternating current motor. It may use permanent magnets for excitation, which may reduce manufacturing and assembly costs and improve the operation reliability of the motor. Since it does not require an excitation current and has no excitation loss, the efficiency and power density of the motor can be increased, making it widely used in various fields.

During the effective operation of the permanent magnet synchronous motor, it is necessary to obtain an accurate rotor position signal in real time to ensure a stable alternating current output from the motor. The rotor position signal is typically collected by a sensor. If the motor components are improperly installed or have aged with use, the rotor position signal becomes nonlinear, which further causes fluctuation of motor torque and severely affects the normal use of the product. The existing technical solution involves compensation and calibration on a test bench for the permanent magnet synchronous motor to correct the nonlinear effect during an offline operation of the motor. This solution relies on test bench resources and requires a highly accurate position signal sensor on the test bench. Therefore, in the conventional technology, the effectiveness of the rotor position compensation and calibration depends on the performance of the test bench, and the calibration scenarios are fixed, which is not suitable for the permanent magnet synchronous motor in actual application scenarios.

### SUMMARY OF THE DISCLOSURE

A rotor position calibration method, a rotor position calibration device and a storage medium are provided according to the present disclosure to solve the technical problem in the conventional technology, which is that a rotor position signal of a permanent magnet synchronous motor may be nonlinear during operation, which causes fluctuation of a motor torque. Accordingly, a rotor position can be calibrated to obtain a real-time and accurate rotor position signal.

According to an aspect of the present disclosure, a rotor position calibration method is provided, which is applied to a permanent magnet synchronous motor. The method includes:
determining, according to a preset target rotational speed, a theoretical position of a target point on a rotor of the motor in correspondence with the target rotational speed at each of periodic time points;
determining a target driving force according to the target rotational speed, applying the target driving force to the rotor to rotate the rotor, and monitoring an actual position of the target point at each of the periodic time points in real time;
determining position errors at multiple time points in a preset measurement period according to the theoretical positions and the actual positions; and
determining an error curve based on the position errors, and calibrating a rotor position based on the error curve.

Further, the determining, according to the preset target rotational speed, the theoretical position of the target point on the rotor of the motor in correspondence with the target rotational speed at each of the periodic time points includes:
obtaining a theoretical rotation angle of the rotor according to an operating time of the target point and the target rotational speed, and obtaining the theoretical position according to the theoretical rotation angle and an initial position of the rotor.

Further, the determining the target driving force according to the target rotational speed includes:
determining the target driving force based on a field oriented control method and the theoretical position in correspondence with the target rotational speed.

Further, the determining the target driving force based on the field oriented control method and the theoretical position in correspondence with the target rotational speed includes:
obtaining a current motor current of the motor, determining a duty cycle of the motor according to the motor current and the theoretical position, and determining the target driving force based on the duty cycle.

Further, the monitoring the actual position of the target point at each of the periodic time points in real time includes:
monitoring the actual position of the target point at each of the periodic time points by a magnetoelectric position sensor.

Further, the determining the position errors at the multiple time points in the preset measurement period according to the theoretical positions and the actual positions includes:
determining the number of rotation periods of the rotor in the preset measurement period and sampling sequences for sampling the position errors in one of the rotation periods, where the sampling sequences are in correspondence with the respective periodic time points; and
determining, for each of the rotation periods in the preset measurement period, position errors at multiple time points in this rotation period based on the sampling sequences, the theoretical positions and the actual positions.

Further, the determining the error curve based on the position errors includes:
calculating a mean position error of each of the sampling sequences, and determining the error curve based on the mean position errors.

Further, the calibrating the rotor position based on the error curve includes:
determining a current actual position of the target point, determining a current position error in correspondence with the current actual position based on the error curve, and calibrating the rotor position based on a linear interpolation method and the current position error.

Further, the calibrating the rotor position based on the linear interpolation method and the current position error includes:
summing the current actual position and the current position error to obtain a target rotor position of the rotor, and regulating a torque signal of the motor based on the target rotor position to make the rotor position the same as the target rotor position.

Further, before the determining, according to the preset target rotational speed, the theoretical position of the target point on the rotor of the motor in correspondence with the target rotational speed at each of the periodic time points, the method further includes:
obtaining power information of the motor, determining whether the motor is under a no-load condition according to the power information, and calibrating the rotor position in a case that the motor is determined to be under the no-load condition.

According to another aspect of the present disclosure, a rotor position calibration device is further provided, which is applied to a permanent magnet synchronous motor. The device includes:
a theoretical position determination module, which is for determining, according to a preset target rotational speed, a theoretical position of a target point on a rotor of the motor in correspondence with the target rotational speed at each of periodic time points;
a driving module and an actual position monitoring module, where the driving module is for determining a target driving force according to the target rotational speed and applying the target driving force to the rotor to rotate the rotor, and the actual position monitoring module is for monitoring an actual position of the target point at each of the periodic time points in real time;
a position error determination module, which is for determining position errors at multiple time points in a preset measurement period according to the theoretical positions and the actual positions; and
a rotor position calibration module, which is for determining an error curve based on the position errors, and calibrating a rotor position based on the error curve.

According to further another aspect of the present disclosure, a storage medium is further provided according to the present disclosure. Multiple instructions are stored in the storage medium, and the instructions are configured to be loaded by a processor to implement the rotor position calibration method according to any one of the above solutions.

At least the following technical effects can be achieved through one or more embodiments of the present disclosure described hereinabove.

In the technical solutions disclosed in the present disclosure, the theoretical positions and the actual positions of the rotor are determined, and the position errors at the multiple time points are further calculated. Then, the error curve is determined based on the position errors, and finally the rotor position is calibrated based on the error curve. Through the technical solutions of the present disclosure, it is possible to calibrate a nonlinear rotor position and obtain an accurate rotor position signal in real time, thereby avoiding the problem of fluctuation of the motor torque. In addition, the technical solutions of the present solution do not rely on test bench resources, and have no requirements for the rotor calibration scenarios. Even when the permanent magnet synchronous motor is installed on the disclosure equipment, the rotor position can still be calibrated. Therefore, through the technical solutions of the present disclosure, it is possible to obtain an accurate and real-time rotor position signal, and these technical solutions can be widely used in permanent magnet synchronous motors in various scenarios.

### BRIEF DESCRIPTION OF THE DRAWINGS

Specific embodiments of the present disclosure will be described in detail hereinafter in conjunction with the accompanying drawings, so that the technical solutions and other beneficial effects of the present disclosure will be apparent.

FIG. 1 is a flow chart showing steps of a rotor position calibration method according to an embodiment of the present disclosure;

FIG. 2 is a schematic diagram showing that a rotor position is nonlinear according to the present disclosure;

FIG. 3 is a schematic diagram showing a variation of the rotor position according to the present disclosure;

FIG. 4 is another schematic diagram showing that the rotor position is nonlinear according to the present disclosure;

FIG. 5 is a schematic diagram showing position errors in one rotation period according to the present disclosure; and

FIG. 6 is a schematic structural diagram of a rotor position calibration device according to an embodiment of the present disclosure.

### DETAILED DESCRIPTION

Technical solutions according to the embodiments of the present disclosure will be described clearly and completely as follows in conjunction with the accompanying drawings in the embodiments of the present disclosure. It is obvious that the described embodiments are only a part of the embodiments of the present disclosure, rather than all of the embodiments. Based on the embodiments of the present disclosure, all other embodiments obtained by those skilled in the art without creative efforts are deemed to fall into the scope of protection of the present disclosure.

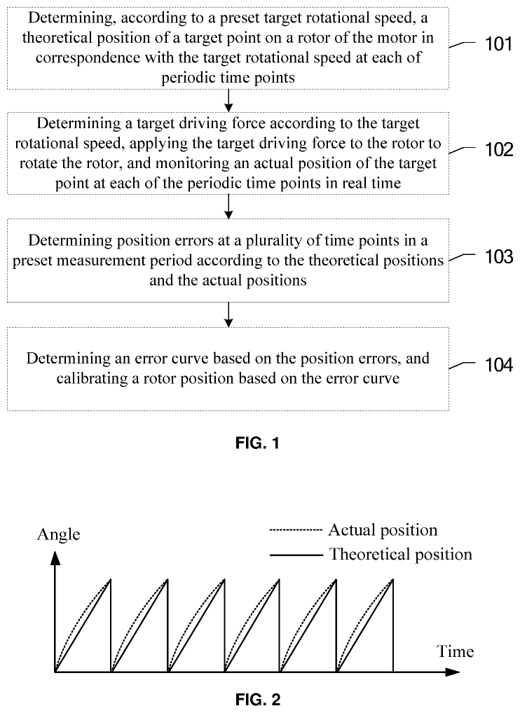

According to an aspect of the present disclosure, a rotor position calibration method is provided. FIG. 1 is a flow chart showing steps of a rotor position calibration method according to an embodiment of the present disclosure. The rotor position calibration method includes the following steps.

In step 101, according to a preset target rotational speed, a theoretical position of a target point on a rotor of the motor in correspondence with the target rotational speed at each of periodic time points is determined.

In step 102, a target driving force is determined according to the target rotational speed, the target driving force is applied to the rotor to rotate the rotor, and an actual position of the target point at each of the periodic time points is monitored in real time.

In step 103, position errors at multiple time points in a preset measurement period are determined according to the theoretical positions and the actual positions.

In step 104, an error curve is determined based on the position errors, and a rotor position is calibrated based on the error curve.

The permanent magnet synchronous motor can be an alternating current motor, which includes a stator, a rotor, an end cap and other components. The rotor is a permanent magnet, and a rotational speed of the rotor is the same as a rotational speed of a rotating magnetic field of the stator. If the motor components are improperly installed or have aged with use, the rotor position signal becomes nonlinear, which further causes fluctuation of motor torque and severely affects the normal use of the product. FIG. 2 is a schematic diagram showing that a rotor position is nonlinear according to the present disclosure. Normally, the real-time actual position of the rotor should be the same as the theoretical position. However, improper installation or aging of the motor will cause nonlinearity. When the motor is operating, the rotor is in the actual position in FIG. 2, and there is a position deviation between the theoretical position and the actual position. With the present solution, the position deviation of the rotor can be corrected without relying on a test bench. A necessary condition is to keep the motor in a stable state at a self-balanced speed. The prerequisite for eliminating the position error of the rotor is to make the motor rotate at the target rotational speed based on the theoretical position of the rotor. When the motor stably rotates at the target rotational speed, the error can be eliminated.

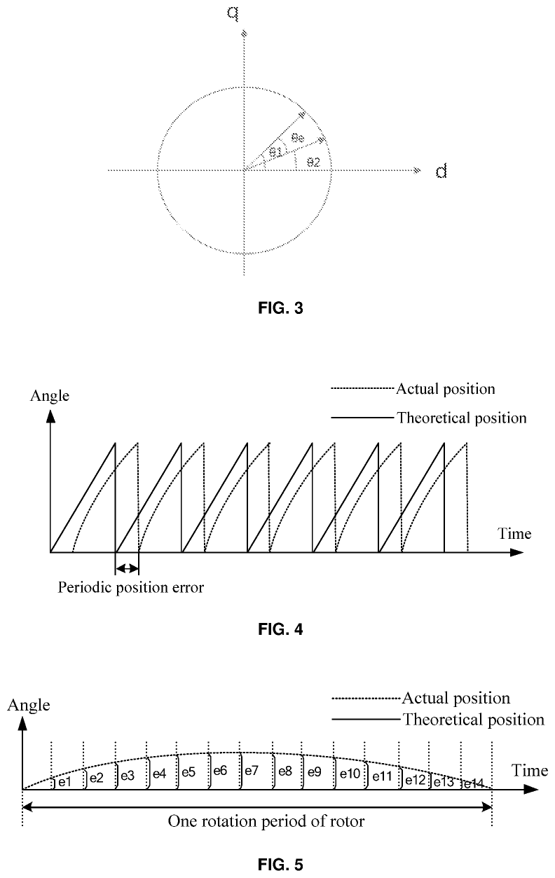

An example is provided hereinafter for illustrating how to keep the motor in the stable state. FIG. 3 is a schematic diagram showing a variation of the rotor position according to the present disclosure. Assuming that a resisting force of the motor is 1 Nm and a driving force of the motor is 5 Nm. When the driving force of the motor is greater than the resistance of the motor, the rotor accelerates. As shown in FIG. 3, assuming that a given virtual rotational speed is 20 rpm, and a theoretical position signal θ2 of a certain frequency is generated. An actual position θ1 of the rotor gradually approaches the theoretical position (at a rotational speed not exceeding 20 rpm) during the acceleration process. When an actual rotational speed exceeds the set 20 rpm, as shown in FIG. 3, the actual position θ1 will exceed the theoretical position θ2. An angle θe between the actual position θ1 and the theoretical position θ2 can be regarded as a power angle, and a motor torque, a motor current and the power angle satisfy the following relationship:

$$Tq = Iq * COS ( θ e ) ,$$

where Tq represents the motor torque, Iq represents the motor current, and θe represents the power angle.

From the relationship of the motor torque, the motor current and the power angle, it can be known that a magnitude of the torque depends on an actual motor current. The accuracy of the motor current is related to the accuracy of the rotor position. The more accurate the rotor position is, the closer the actual motor current is to a target current. It can be seen that, taking the theoretical position θ2 of the rotor as a reference, if the rotor position deviates from the theoretical position θ2, the accuracy of the motor current and the rotor position will decrease. The accuracy of the position may be represented by COS(θe).

During the variation of the rotor position shown in FIG. 3, when the actual position θ1 exceeds the theoretical position θ2, an increase of the power angle Oe will cause a decrease of the motor torque Tq. Correspondingly, the rotational speed of the rotor decreases, thereby slowing down the actual position θ1. When the actual position θ1 gradually approaches the theoretical position θ2, the power angle Oe decreases. The larger the deviation of the accuracy of the rotor position, the smaller the COS(θe), and the smaller the torque being generated. The decreased torque reduces the rotational speed of the actual rotor position.

When the power angle θe decreases, the motor torque Tq increases, the rotor of the motor accelerates, and the acceleration causes the actual position θ1 to gradually deviate from the theoretical position θ2. Correspondingly, the power angle θe increases.

By repeatedly regulating the above two processes, the deviation between the actual position θ1 and the theoretical position θ2 is reduced until the power angle θe is zero.

In the present disclosure, the rotor position needs to be calibrated when the motor is under a no-load condition. For example, calibration-related data is predetermined under the no-load condition before the motor leaves the factory, or under a quasi-no-load condition created when the motor is operating.

The position error of the rotor of the motor is mainly caused by installation positions of a position sensor and the magnet. Therefore, after the device is packaged, a value of the error caused by the positions varies less. Different rotational speeds of the rotor will only cause different operating periods of the rotor, but will not cause a significant variation in the error value. After the data related to the rotor calibration is determined, the data may be saved, and the rotor can be calibrated using the same data in a preset time.

The above steps 101 to 104 are described in detail hereinafter.

In step 101, according to the preset target rotational speed, the theoretical position of the target point on the rotor of the motor in correspondence with the target rotational speed at each of the periodic time points is determined.

Exemplarily, the rotor of the permanent magnet synchronous motor is a permanent magnet. During the operation of the motor, the rotational speed of the rotor is the same as the rotational speed of the rotating magnetic field of the stator. Before setting operating parameters of the motor, the target rotational speed of the rotor is preset according to information such as parameters of the required alternating current. The motor current is regulated based on the target rotational speed, and the motor torque is further regulated to rotate the rotor. The rotor and the stator are provided with a preset initial point, i.e., an initial position of the target point. When the rotor rotates stably, a time when the target point passes the initial position is recorded, and a rotation period of the rotor starts. In each period, the theoretical position of the target point is calculated based on the periodic time point and the target rotational speed.

In step 102, the target driving force is determined according to the target rotational speed, the target driving force is applied to the rotor to rotate the rotor, and the actual position of the target point at each of the periodic time points is monitored in real time.

Exemplarily, in the permanent magnet synchronous motor, when the motor current and the rotor position are determined, a duty cycle of the motor can be determined. An internal feedback is formed in the motor via the duty cycle, and the motor current is regulated based on the duty cycle. That is, the target driving force of the motor is regulated, so as to further change the motor torque to make the rotor rotate at the target rotational speed. The motor is provided with a position sensor for monitoring rotor position information in real time. Various types of position sensors may be used to determine current position information of the rotor in real time. In the present disclosure, before the position sensor obtains the position signal, multiple periodic time points are preset based on a time of the period and an accuracy standard. Each period is divided into a preset number of time periods, and the position information of the rotor is acquired at a preset time point of each time period.

In step 103, the position errors at the multiple time points in the preset measurement period are determined according to the theoretical positions and the actual positions.

Exemplarily, the measurement period is preset in advance. The preset measurement period includes multiple rotation periods of the rotor. After the motor is started and when the rotational speed of the rotor is stable, in the preset measurement period, the position errors at the multiple time points in each period are calculated according to the calculated theoretical positions and the actual positions monitored in real time.

In the schematic diagram in FIG. 2 showing the variation of the rotor position, a periodic position error between the actual position and the theoretical position is ignored. FIG. 4 is another schematic diagram showing that the rotor position is nonlinear according to the present disclosure. More precisely, the schematic diagram of the actual position and the theoretical position is as shown in FIG. 4. The real position error is an addition of the periodic position error and the position errors in FIG. 2. In practice, the periodic position error in FIG. 4 can be easily eliminated. Hence, the rotor position calibration method according to the present solution is provided on the basis of the elimination of the periodic position error. Therefore, in the present solution, the position error defaults to an error between the actual position and the theoretical position at the same time point shown in FIG. 2. FIG. 5 is a schematic diagram showing position errors according to the present disclosure. As shown in FIG. 5, during the variation of the rotor position in one rotation period of the rotor, there is a deviation between the actual position and the theoretical position. In the example shown in FIG. 5, the one rotation period of the rotor is divided into 15 parts. Correspondingly, there are 14 position errors at 14 time points.

In step 104, the error curve is determined based on the position errors, and the rotor position is calibrated based on the error curve.

Exemplarily, after determining the multiple position errors, data processing is performed on the multiple position errors to fit the error curve. During the operation of the motor, the actual position of the motor rotor is obtained in real time, and the rotor position is calibrated according to the error curve, so that the permanent magnet synchronous motor operates accurately and stably.

Further, the step of determining, according to the preset target rotational speed, the theoretical position of the target point on the rotor of the motor in correspondence with the target rotational speed at each of the periodic time points includes the following steps.

A theoretical rotation angle of the rotor is obtained according to an operating time of the target point and the target rotational speed, and the theoretical position is obtained according to the theoretical rotation angle and an initial position of the rotor.

Exemplarily, when the rotor of the permanent magnet synchronous motor stably rotates, a time when the target point is at the initial position is determined, and the operating time of the rotor is calculated in real time based on the current time and the initial time. Then, the theoretical rotation angle by which the rotor has rotated at the current time is determined based on the operating time and the target rotational speed. The initial position of the rotor is obtained, the theoretical rotation angle is added to an angle in correspondence with the initial position, and then the theoretical rotation angle is converted to a central angle to obtain the theoretical position.

Further, the step of determining the target driving force according to the target rotational speed includes the following step.

The target driving force is determined based on a field oriented control method and the theoretical position in correspondence with the target rotational speed.

Further, the step of determining the target driving force based on the field oriented control method and the theoretical position in correspondence with the target rotational speed includes the following steps.

A current motor current of the motor is obtained, a duty cycle of the motor is determined according to the motor current and the theoretical position, and the target driving force is determined based on the duty cycle.

Exemplarily, the duty cycle of the motor is determined by the field oriented control (FOC) method and the theoretical position. The motor current is regulated according to the duty cycle, so as to further regulate the motor torque to make the motor operate at a specified speed. The duty cycle refers to a ratio of a power-on time to a power-on period of a pulse signal. In an ideal pulse periodic sequence (such as a square wave), the duty cycle is a ratio of a duration of a positive pulse to a total pulse period. The duty cycle refers to a ratio of the time of a high level in a period. The square wave has a duty cycle of 50%. The duty cycle is 0.5, which means that the positive level occupies 0.5 periods.

The field oriented control (FOC) method is also referred to as vector control. Its principle is to transform the control of a three-phase alternating current into the control of a q-axis current which generates the torque and a d-axis current which generates the magnetic field through coordinate transformation, so as to achieve independent control of the torque and the excitation. The magnetic field is represented in the form of a space vector. It is known that the torque is maximized when a direction of a magnetic field of the stator is perpendicular to a direction of a magnetic field of the rotor. Therefore, it can be ensured that the motor has a good performance if the directions of the magnetic fields of the stator and the rotor are always perpendicular to each other.

Further, the step of monitoring the actual position of the target point at each of the periodic time points in real time includes the following step.

The actual position of the target point at each of the periodic time points is monitored by a magnetoelectric position sensor.

Exemplarily, the permanent magnet synchronous motor is provided with a sensor for measuring the rotor position. Specifically, the actual position of the target point at the periodic time point is monitored by the magnetoelectric position sensor. The magnetoelectric sensor is also referred to as an electric or inductive sensor, which is only suitable for dynamic measurement. The principle of the magnetoelectric sensor is to convert an input motion speed into an induced potential output in a coil via electromagnetic induction. As a typical passive sensor, the magnetoelectric sensor directly converts the mechanical energy of a measured object into an electrical signal output, and requires no external power supply for operation. The magnetoelectric position sensor has large output power, a simple circuit, and a stable zero position and performance, and thus is widely used. It should be noted that, in practice, the type of the sensor is not limited, and other position sensors may be used, such as a Hall position sensor and an inductive position sensor. The optimal sensor may be determined according to practice.

Further, the step of determining the position errors at the multiple time points in the preset measurement period according to the theoretical positions and the actual positions includes the following steps.

The number of rotation periods of the rotor in the preset measurement period and sampling sequences for sampling the position errors in one of the rotation periods are determined. The sampling sequences are in correspondence with the respective periodic time points.

For each of the rotation periods in the preset measurement period, position errors at multiple time points in this rotation period are determined based on the sampling sequences, the theoretical positions and the actual positions.

Exemplarily, the preset measurement period includes multiple rotation periods. For example, if the preset measurement period includes 10 rotation periods of the rotor, rotor position data in the 10 periods is acquired to calculate the position errors. To improve the accuracy of the rotor position calibration, more rotor rotation periods may be provided, such as 20 or 50 rotor rotation periods, which can make the position calibration more accurate.

After determining the number of the rotation periods of the rotor in the preset measurement period, sampling is performed at multiple preset time points for each rotation period to calculate the position errors of the rotor. FIG. 5 is a schematic diagram showing position errors according to the present disclosure. As shown in FIG. 5, in one rotation period, there are 14 sampling sequences in correspondence with 14 periodic time points respectively.

Suppose that the preset measurement period includes 10 rotation periods of the rotor and there are 14 position errors in each rotation period. There are 140 position errors in the preset measurement period.

Further, the step of determining the error curve based on the position errors includes the following steps.

A mean position error of each of the sampling sequences is calculated, and the error curve is determined based on the mean position errors.

For each of the sampling sequences, a target position error in correspondence with the sampling sequence in each rotation period in the preset measurement period is obtained, so as to obtain multiple target position errors in correspondence with this sampling sequence. A mean value of the multiple target position errors is calculated to obtain a mean position error corresponding to this sampling sequence.

Specifically, in order to improve the accuracy of error calibration, after obtaining all the position errors in the preset measurement period, for each of the sampling sequences, the target position errors in correspondence with this sampling sequence from all rotation periods are obtained. Data processing is applied to the position errors in correspondence with each sampling sequence, and the mean of the multiple target position errors is calculated, so as to obtain multiple mean position errors. For example, if the corresponding preset measurement period includes 10 rotation periods of the rotor and there are 14 position errors in each rotation period, there will be 140 position errors in the preset measurement period. For each of the 14 sampling sequences, the mean of the 10 position errors in correspondence with this sequence is calculated, so as to obtain 14 mean position errors.

After all the mean position errors are determined, data processing is applied to the mean position errors, and the error curve is fitted based on a mathematical optimization algorithm.

Further, the step of calibrating the rotor position based on the error curve includes the following steps.

A current actual position of the target point is determined, a current position error in correspondence with the current actual position is determined based on the error curve, and the rotor position is calibrated based on a linear interpolation method and the current position error.

Exemplarily, after the error curve is determined, the rotor position can be calibrated based on the error curve. The rotor position can also be calibrated with the position errors at the multiple preset time points. In an embodiment, the multiple mean position errors can be directly processed by the linear interpolation method, and the rotor position can be compensated using the mean position errors. In an embodiment, at the current time of the rotor operation, the current actual position is obtained, and the position error in correspondence with the current actual position on the error curve is obtained, and then the rotor position is calibrated using the linear interpolation method and the position error.

The linear interpolation method refers to an interpolation method in which an interpolation function is a first-order polynomial, and an interpolation error at an interpolation node is zero. Compared with other interpolation methods, such as parabolic interpolation, the linear interpolation is simple and convenient.

Further, the step of calibrating the rotor position based on the linear interpolation method and the current position error includes the following steps.

The current actual position and the current position error are summed to obtain a target rotor position of the rotor, and a torque signal of the motor is regulated based on the target rotor position to make the rotor position the same as the target rotor position.

Exemplarily, when controlling the rotational speed of the motor, two control signals are input. One of the control signals is related to the position that the rotor is expected to reach, and the other is related to the torque. In the present disclosure, in order to make the rotor position the same as the target rotor position, the target rotor position of the rotor in the current state is calculated first, and then the torque signal of the motor is regulated based on the target rotor position. The motor regulates the rotational speed of the rotor according to the torque signal to complete the calibration of the rotor position.

Further, before the step of determining, according to the preset target rotational speed, the theoretical position of the target point on the rotor of the motor in correspondence with the target rotational speed at each of the periodic time points, the method further includes the following steps.

Power information of the motor is obtained, whether the motor is under a no-load condition is determined according to the power information, and the rotor position is calibrated in a case that the motor is determined to be under the no-load condition.

Exemplarily, in order to ensure the accuracy of the measured position errors, it is necessary to ensure that the motor is under the no-load condition when the position errors are obtained. For example, calibration-related data is pre-determined under the no-load condition before the motor leaves the factory, or under a quasi-no-load condition created when the motor is operating.

At least the following technical effects can be achieved through one or more embodiments of the present disclosure described hereinabove.

In the technical solutions disclosed in the present disclosure, the theoretical positions and the actual positions of the rotor are determined, and the position errors at the multiple time points are further calculated. Then, the error curve is determined based on the position errors, and finally the rotor position is calibrated based on the error curve. Through the technical solutions of the present disclosure, it is possible to calibrate a nonlinear rotor position and obtain an accurate rotor position signal in real time, thereby avoiding the problem of fluctuation of the motor torque. In addition, the technical solutions of the present solution do not rely on test bench resources, and has no requirements for the rotor calibration scenarios. Even when the permanent magnet synchronous motor is installed on the disclosure equipment, the rotor position can still be calibrated. Therefore, through the technical solutions of the present disclosure, it is possible to obtain an accurate and real-time rotor position signal, and these technical solutions can be widely used in permanent magnet synchronous motors in various scenarios.

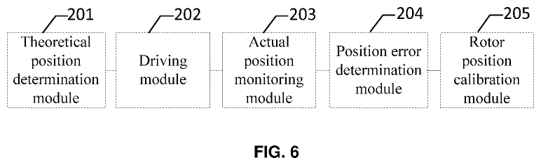

Based on a similar concept as that of the rotor position calibration method according to the embodiments of the present disclosure, a rotor position calibration device is further provided according to an embodiment of the present disclosure, which is applied to a permanent magnet synchronous motor. Referring to FIG. 6, the device includes:
a theoretical position determination module 201, which is for determining, according to a preset target rotational speed, a theoretical position of a target point on a rotor of the motor in correspondence with the target rotational speed at each of periodic time points;
a driving module 202 and an actual position monitoring module 203, which are respectively for determining a target driving force according to the target rotational speed and applying the target driving force to the rotor to rotate the rotor, and for monitoring an actual position of the target point at each of the periodic time points in real time;
a position error determination module 204, which is for determining position errors at multiple time points in a preset measurement period according to the theoretical positions and the actual positions; and
a rotor position calibration module 205, which is for determining an error curve based on the position errors, and calibrating a rotor position based on the error curve.

Further, the theoretical position determination module 201 is further for:
obtaining a theoretical rotation angle of the rotor according to an operating time of the target point and the target rotational speed, and obtaining the theoretical position according to the theoretical rotation angle and an initial position of the rotor.

Further, the driving module 202 is further for:
determining the target driving force based on a field oriented control method and the theoretical position in correspondence with the target rotational speed.

Further, the driving module 202 is further for:
obtaining a current motor current of the motor, determining a duty cycle of the motor according to the motor current and the theoretical position, and determining the target driving force based on the duty cycle.

Further, the actual position monitoring module 203 is further for:
monitoring the actual position of the target point at each of the periodic time points by a magnetoelectric position sensor.

Further, the position error determination module 204 is further for:
determining the number of rotation periods of the rotor in the preset measurement period and sampling sequences for sampling the position errors in one of the rotation periods, where the sampling sequences are in correspondence with the respective periodic time points; and
determining, for each of the rotation periods in the preset measurement period, position errors at multiple time points in this rotation period based on the sampling sequences, the theoretical positions and the actual positions.

Further, the rotor position calibration module 205 is further for:
calculating a mean position error of each of the sampling sequences, and determining the error curve based on the mean position errors.

Further, the rotor position calibration module 205 is further for:
obtaining, for each of the sampling sequences, a target position error in correspondence with the sampling sequence in each rotation period in the preset measurement period, so as to obtain multiple target position errors in correspondence with the sampling sequence; and
calculating a mean value of the multiple target position errors to obtain a mean position error corresponding to the sampling sequence.

Further, the rotor position calibration module 205 is further for:
determining a current actual position of the target point, determining a current position error in correspondence with the current actual position based on the error curve, and calibrating the rotor position based on a linear interpolation method and the current position error.

Other aspects and implementation details of the rotor position calibration device are the same as or similar to the rotor position calibration method described hereinabove, and will not be repeated herein.

According to further another aspect of the present disclosure, a storage medium is further provided according to the present disclosure. Multiple instructions are stored in the storage medium, and the instructions are configured to be loaded by a processor to implement the rotor position calibration method according to any one of the above solutions.

In summary, although the present disclosure is disclosed by the above preferred embodiments, the preferred embodiments should not be construed as limitations to the present disclosure. For those skilled in the art, many variations and modifications may be made without departing from the spirit and scope of the present disclosure, and the protection scope of the present disclosure is based on the scope defined by the claims.

1. A rotor position calibration method, which is applied to a permanent magnet synchronous motor, the method comprising:
determining, according to a preset target rotational speed, a theoretical position of a target point on a rotor of the permanent magnet synchronous motor in correspondence with the preset target rotational speed at each of periodic time points;
determining a target driving force according to the preset target rotational speed, applying the target driving force to the rotor to rotate the rotor, and monitoring an actual position of the target point at each of the periodic time points in real time;
determining position errors at a plurality of time points in a preset measurement period according to the theoretical positions and the actual positions; and
determining an error curve based on the position errors, and calibrating a rotor position based on the error curve.

2. The method of claim 1, wherein the determining, according to the preset target rotational speed, the theoretical position of the target point on the rotor of the motor in correspondence with the preset target rotational speed at each of the periodic time points comprises:
obtaining a theoretical rotation angle of the rotor according to an operating time of the target point and the preset target rotational speed, and obtaining the theoretical position according to the theoretical rotation angle and an initial position of the rotor.

3. The method of claim 1, wherein the determining the target driving force according to the preset target rotational speed comprises:
determining the target driving force based on a field oriented control method and the theoretical position in correspondence with the preset target rotational speed.

4. The method of claim 3, wherein the determining the target driving force based on the field oriented control method and the theoretical position in correspondence with the preset target rotational speed comprises:
obtaining a current motor current of the motor, determining a duty cycle of the motor according to the motor current and the theoretical position, and determining the target driving force based on the duty cycle.

5. The method of claim 1, wherein the monitoring the actual position of the target point at each of the periodic time points in real time comprises:
monitoring the actual position of the target point at each of the periodic time points by a magnetoelectric position sensor.

6. The method of claim 1, wherein the determining the position errors at the plurality of time points in the preset measurement period according to the theoretical positions and the actual positions comprises:
determining a number of rotation periods of the rotor in the preset measurement period and sampling sequences for sampling the position errors in one of the rotation periods, wherein the sampling sequences are in correspondence with the respective periodic time points; and
determining, for each of the rotation periods in the preset measurement period, position errors at a plurality of time points in the one of the rotation periods based on the sampling sequences, the theoretical positions-positions, and the actual positions.

7. The method of claim 6, wherein the determining the error curve based on the position errors comprises:
calculating a mean position error of each of the sampling sequences, and determining the error curve based on the mean position errors.

8. The method of claim 1, wherein the calibrating the rotor position based on the error curve comprises:
determining a current actual position of the target point, determining a current position error in correspondence with the current actual position based on the error curve, and calibrating the rotor position based on a linear interpolation method and the current position error.

9. The method of claim 8, wherein the calibrating the rotor position based on the linear interpolation method and the current position error comprises:
summing the current actual position and the current position error to obtain a target rotor position of the rotor, and regulating a torque signal of the motor based on the target rotor position to make the rotor position the same as the target rotor position.

10. The method of claim 1, wherein before the determining, according to the preset target rotational speed, the theoretical position of the target point on the rotor of the motor in correspondence with the preset target rotational speed at each of the periodic time points, comprises: obtaining power information of the motor, determining whether the motor is under a no-load condition according to the power information, and calibrating the rotor position in a case that the motor is determined to be under the no-load condition.

11. A rotor position calibration device, which is applied to a permanent magnet synchronous motor, comprising:
a theoretical position determination module that determines, according to a preset target rotational speed, a theoretical position of a target point on a rotor of the permanent magnet synchronous motor in correspondence with the preset target rotational speed at each of periodic time points;
a driving module that determines a target driving force according to the preset target rotational speed and applying the target driving force to the rotor to rotate the rotor;
an actual position monitoring module that monitors an actual position of the target point at each of the periodic time points in real time;
a position error determination module that determines position errors at a plurality of time points in a preset measurement period according to the theoretical positions and the actual positions; and
a rotor position calibration module, which is for determining an error curve based on the position errors, and calibrating a rotor position based on the error curve.

12. A device for rotor position calibration, comprising:
a storage medium storing instructions; and
at least one processor configured to execute the instructions to:
determine, according to a target rotational speed, a theoretical position of a target point on a rotor of a motor in correspondence with the target rotational speed at each of periodic time points;
determine a target driving force according to the target rotational speed;
apply the target driving force to the rotor to rotate the rotor;
monitor an actual position of the target point at each of the periodic time points in real time;
determine position errors at a plurality of time points in a measurement period according to the theoretical positions and the actual positions;
determine an error curve based on the position errors; and
calibrate a rotor position based on the error curve.

13. The device of claim 12, wherein the at least one processor is configured to execute the instructions to determine the target driving force based on a field oriented control method and the theoretical position in correspondence with the target rotational speed when determining the target driving force according to the target rotational speed.

14. The device of claim 13, wherein the at least one processor is configured to execute the instructions to obtain a current motor current of the motor, determine a duty cycle of the motor according to the motor current and the theoretical position, and determine the target driving force based on the duty cycle when determining the target driving force based on the field oriented control method and the theoretical position in correspondence with the target rotational speed.

15. The device of claim 12, wherein the at least one processor is configured to execute the instructions to monitor the actual position of the target point at each of the periodic time points by a magnetoelectric position sensor when monitoring the actual position of the target point at each of the periodic time points in real time.

16. The device of claim 12, wherein the at least one processor is configured to execute the instructions to, when determining the position errors at the plurality of time points in the measurement period according to the theoretical positions and the actual positions:
determine a number of rotation periods of the rotor in the measurement period and sampling sequences for sampling the position errors in one of the rotation periods, wherein the sampling sequences are in correspondence with the respective periodic time points; and
determine, for each of the rotation periods in the measurement period, position errors at a plurality of time points in the one of the rotation periods based on the sampling sequences, the theoretical positions, and the actual positions.

17. The device of claim 16, wherein the at least one processor is configured to execute the instructions to, when determining the error curve based on the position errors:
calculate a mean position error of each of the sampling sequences; and
determine the error curve based on the mean position errors.

18. The device of claim 12, wherein the at least one processor is configured to execute the instructions to, when calibrating the rotor position based on the error curve:
determine a current actual position of the target point;
determine a current position error in correspondence with the current actual position based on the error curve; and
calibrate the rotor position based on a linear interpolation method and the current position error.

19. The device of claim 18, wherein the at least one processor is configured to execute the instructions to, when calibrating the rotor position based on the linear interpolation method and the current position error:
sum the current actual position and the current position error to obtain a target rotor position of the rotor; and
regulate a torque signal of the motor based on the target rotor position to make the rotor position the same as the target rotor position.

20. The device of claim 12, wherein the at least one processor is configured to execute the instructions to:
obtain power information of the motor;
determine whether the motor is under a no-load condition according to the power information; and
calibrate the rotor position in a case that the motor is determined to be under the no-load condition.
